(19) United States
(12) Patent Application Publication
(10) Pub. No.: US 2025/0208261 A1
(43) Pub. Date: Jun. 26, 2025

(54) DISTANCE MEASURING MODULE

(71) Applicant: SONY SEMICONDUCTOR SOLUTIONS CORPORATION, KANAGAWA (JP)

(72) Inventor: KAZUHIRO NAGATA, KANAGAWA (JP)

(21) Appl. No.: 18/848,511

(22) PCT Filed: Mar. 13, 2023
(86) PCT No.: PCT/JP2023/009512

§ 371 Date: Sep. 18, 2024

(30) Foreign Application Priority Data
Mar. 28, 2022 (JP) 2022-051130

(51) Int. Cl. G01S 7/481; G01S 17/08; G01S 17/86; G01S 17/894

(52) U.S. Cl. CPC G01S 7/4815; G01S 7/4813; G01S 17/08; G01S 17/86; G01S 17/894

(57) ABSTRACT

The present disclosure relates to a distance measuring module which can achieve both wide-angle distance measurement and downsizing of the apparatus. A distance measuring module (100) includes: a plurality of light emitting devices (111a, 111b) that emits irradiation light to a distance measuring object; and an imaging device (112) that captures an image of reflected light of the irradiation light reflected by the distance measuring object, in which the plurality of light emitting devices (111a, 111b) is disposed in such positions and at such angles that a combined irradiation range including an overlapping portion of respective irradiation ranges (111Ra, 111Rb) of the irradiation light includes an imaging range (112R) of the imaging device (112). The present disclosure can be applied to a ToF camera.

### TECHNICAL FIELD

The present disclosure relates to a distance measuring module, and particularly to a distance measuring module which can achieve both wide-angle distance measurement and downsizing of the apparatus.

### BACKGROUND ART

As a method of measuring a distance to an object to obtain a distance image, a time of flight (ToF) method is known, in which the distance is measured on the basis of a flight time of irradiation light until it returns after being reflected by the object.

For example, Patent Document 1 discloses an omnidirectional distance measuring device that covers a wide detection range by ToF sensors which are disposed close to each other radially around a central axis.

### CITATION LIST

### Patent Document

Patent Document 1: Japanese Patent Application Laid-Open No. 2021-99278

### SUMMARY OF THE INVENTION

### Problems to be Solved by the Invention

In order to achieve wide-angle distance measurement in the distance measuring module in which the ToF method is employed, it is conceivable to dispose a plurality of distance measuring modules as disclosed in Patent Document 1, but the size of the apparatus becomes large.

The present disclosure has been made in view of such a situation, and an object thereof is to achieve both wide-angle distance measurement and downsizing of the apparatus.

### Solutions to Problems

A distance measuring module of the present disclosure is a distance measuring module including: a plurality of light emitting devices that emits irradiation light to a distance measuring object; and an imaging device that captures an image of reflected light of the irradiation light reflected by the distance measuring object, in which the plurality of light emitting devices is disposed in such positions and at such angles that a combined irradiation range including an overlapping portion of respective irradiation ranges of the irradiation light includes an imaging range of the imaging device.

According to the present disclosure, in the distance measuring module including: the plurality of light emitting devices that emits irradiation light to a distance measuring object; and the imaging device that captures an image of reflected light of the irradiation light reflected by the distance measuring object, the plurality of light emitting devices is disposed in such positions and at such angles that a combined irradiation range including an overlapping portion of respective irradiation ranges of the irradiation light includes an imaging range of the imaging device.

### BRIEF DESCRIPTION OF DRAWINGS

FIG. 1 is a diagram illustrating a configuration example of a conventional distance measuring module.

FIG. 2 is a diagram illustrating a configuration example of a distance measuring module according to a first embodiment.

FIG. 3 is a perspective view illustrating a configuration example of a ToF camera according to the first embodiment.

FIG. 4 is a front view illustrating the configuration example of the ToF camera according to the first embodiment.

FIG. 5 is a diagram for explaining a positional relationship among LDs and a camera in the ToF camera.

FIG. 6 is a diagram illustrating a configuration example of a distance measuring module according to a second embodiment.

FIG. 7 is a diagram illustrating a configuration example of a distance measuring module according to a third embodiment.

FIG. 8 is a diagram illustrating an application example of the distance measuring module.

### MODE FOR CARRYING OUT THE INVENTION

Hereinafter, modes for carrying out the present disclosure (hereinafter referred to as embodiments) will be described. Note that the description will be given in the following order.
1. Conventional Distance Measuring Module and Problems Thereof
2. First Embodiment (Configuration in Which Housing Frame Serves as Support Structure)
3. Second Embodiment (Configuration in Which Support Substrate Serves as Support Structure)
4. Third Embodiment (Configuration for Achieving Vertically-Wide Distance Measurement)
5. Application Example

### 1. Conventional Distance Measuring Module and Problems Thereof

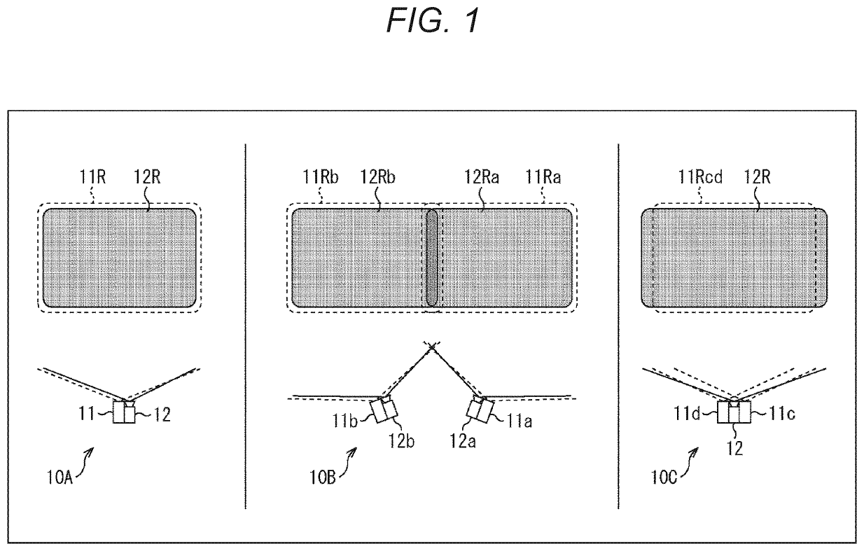

FIG. 1 is a diagram illustrating a configuration example of a conventional distance measuring module.

Each of distance measuring modules 10A, 10B, and 10C illustrated in FIG. 1 constitutes a time of flight (ToF) camera capable of measuring three-dimensional information using a flight time of light.

The distance measuring modules 10A, 10B, and 10C irradiate a distance measuring object with light from a light emitting device such as a light-emitting diode (LED) or a laser diode (LD) to measure the distance to the distance measuring object by the ToF method, on the basis of a time difference until the reflected light is detected by an imaging device (camera).

The distance measuring module 10A includes a light emitting device 11 and an imaging device 12.

The light emitting device 11 is disposed such that a light emitting direction thereof is the same as an imaging direction (light receiving direction) of the imaging device 12.

The light emitting device 11 emits irradiation light to a distance measuring object, and the imaging device 12 images reflected light of irradiation light emitted by the light emitting device 11 and reflected by the distance measuring object. The distance measuring module 10A is configured such that an imaging range 12R of the imaging device 12 is included in an irradiation range 11R of the irradiation light, whereby the distance image of the distance measuring object can be obtained.

In general, the imaging range of the imaging device can be widened by using a wide-angle lens having an angle of view of 160°, for example. On the other hand, the upper limit of the light emission angle that determines the irradiation range of the light emitting device has been about 140°. Therefore, the imaging range of the imaging device has also been limited to about 140°, and there has been a limit to achieve wider-angle distance measurement in the distance measuring module 10A.

On the other hand, the distance measuring module 10B includes a pair of light emitting device 11a and imaging device 12a and a pair of light emitting device 11b and imaging device 12b.

The distance measuring module 10B is configured such that an imaging range 12Ra of the imaging device 12a is included in an irradiation range 11Ra of the light emitting device 11a, and an imaging range 12Rb of the imaging device 12b is included in an irradiation range 11Rb of the light emitting device 11b. Furthermore, in the distance measuring module 10B, the imaging device 12a and the imaging device 12b are disposed such that parts of the respective imaging ranges 12Ra and 12Rb overlap each other.

In this manner, wide-angle distance measurement can be achieved in the distance measuring module 10B due to the disposition of the plurality of modules each including a pair of imaging device and light emitting device. However, the disposition of a plurality of light emitting devices and a plurality of imaging devices increases the size of the apparatus.

Meanwhile, the distance measuring module 10C includes a pair of light emitting devices 11c and 11d and an imaging device 12. The light emitting devices 11c and 11d are disposed so as to sandwich the imaging device 12 such that the respective light emitting directions of the light emitting devices 11c and 11d are the same as the imaging direction (light receiving direction) of the imaging device 12.

The distance measuring module 10C is configured such that an imaging range 12R of the imaging device 12 is wider than that of the distance measuring module 10A by using, for example, a wide-angle lens having an angle of view of 160°. However, although the two light emitting devices 11c and 11d are provided, because of such a disposition that the respective light emitting directions are the same, the irradiation range 11Rcd is not greatly different from the irradiation range in the case of either device alone. For this reason, there has been a limit to achieve wide-angle distance measurement also in the distance measuring module 10C.

Therefore, the technology according to the present disclosure proposes a configuration of a distance measuring module which can achieve wide-angle distance measurement and downsizing of the apparatus. Specifically, there is proposed a distance measuring module including a plurality of light emitting devices and one imaging device, in which the plurality of light emitting devices is disposed in such positions and ranges that a combined irradiation range including an overlapping portion of respective irradiation ranges of irradiation light includes an imaging range of the imaging device.

### 2. First Embodiment

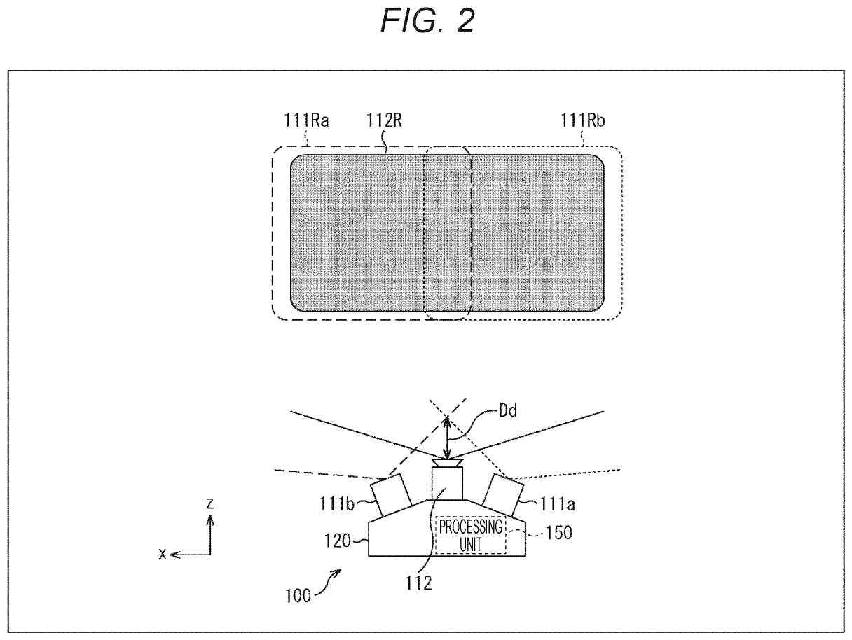

FIG. 2 is a diagram illustrating a configuration example of a distance measuring module of a first embodiment to which the technology according to the present disclosure is applied.

A distance measuring module 100 irradiates a distance measuring object with light from light emitting devices such as LEDs or LDs to measure the distance to the distance measuring object by the ToF method, on the basis of a time difference until the reflected light is detected by the imaging device.

The ToF method used in the distance measuring module 100 may be a direct ToF (dToF) method of simply measuring a time difference until the reflected light is detected, or may be an indirect ToF (iToF) method of measuring the distance by accumulating the reflected light and detecting a phase difference compared to the emitted light.

The distance measuring module 100 illustrated in FIG. 2 includes a pair of light emitting devices 111a and 111b and an imaging device 112.

Each of the light emitting devices 111a and 111b includes an LED, an LD, or the like, and emits irradiation light to a distance measuring object. The imaging device 112 includes a camera including one or a plurality of lenses and an imaging element, and captures an image of reflected light of the irradiation light emitted by the light emitting devices 111a and 111b and reflected by the distance measuring object. The lens included in the imaging device 112 is a wide-angle lens having an angle of view of 140° or more, for example, 160°.

In the following description, an x axis and a y axis are defined as two axes orthogonal to each other on a plane orthogonal to the optical axis direction of the lens of the imaging device 112, and a z axis is defined as the optical axis direction of the lens of the imaging device 112. It is assumed that the imaging surface of the imaging device 112 is on the xy plane.

In the distance measuring module 100, the light emitting devices 111a and 111b are disposed in such positions and at such angles that a combined irradiation range including an overlapping portion of respective irradiation ranges 111Ra and 111Rb of the irradiation light includes an imaging range 112R of the imaging device 112.

Specifically, the light emitting devices 111a and 111b are disposed so as to sandwich the imaging device 112 such that the respective light emitting directions have an inclination with respect to the optical axis of the lens of the imaging device 112. More specifically, the light emitting devices 111a and 111b are disposed such that the respective light emitting directions are line-symmetric with respect to the optical axis direction of the lens (z-axis direction).

Furthermore, although not illustrated, the light emitting devices 111a and 111b are disposed such that the centers of the respective light emitting surfaces and the center of the lens of the imaging device 112 are on substantially the same straight line (in the x-axis direction in the figure).

Furthermore, the light emitting devices 111a and 111b are disposed such that parts of the respective irradiation ranges 111Ra and 111Rb overlap at a distance Dd of at most 50 cm, for example, 30 cm from the lens of the imaging device 112.

In addition, the respective light emitting devices 111a and 111b emit irradiation light having the same light emission intensity at the same timing.

With the above-described disposition of the light emitting devices 111a and 111b, the imaging range 112R of the imaging device 112 is included in the combined irradiation range including the overlapping portion of the respective irradiation ranges 111Ra and 111Rb of the irradiation light.

Furthermore, the distance measuring module 100 includes a support structure 120 that supports the light emitting devices 111a and 111b and the imaging device 112. The support structure 120 may be configured as a housing frame that includes, for example, a control circuit that controls light emission of the light emitting devices 111a and 111b and imaging of the imaging device 112. Furthermore, the support structure 120 may be configured as a support substrate on which the light emitting devices 111a and 111b, the imaging device 112, the above-described control circuit, and the like are mounted.

That is, the support structure 120, which contributes to the above-described disposition of the light emitting devices 111a and 111b, allows the imaging range 112R of the imaging device 112 to be included in the combined irradiation range including the overlapping portion of the respective irradiation ranges 111Ra and 111Rb of the irradiation light.

In addition, the control circuit included in or mounted on the support structure 120 can serve as a processing unit 150. The processing unit 150 performs object detection and object recognition by performing image processing on the distance image captured by the imaging device 112, and outputs a detection result and a recognition result. That is, the distance measuring module 100 can be configured as an electronic apparatus capable of executing object detection and object recognition as a whole.

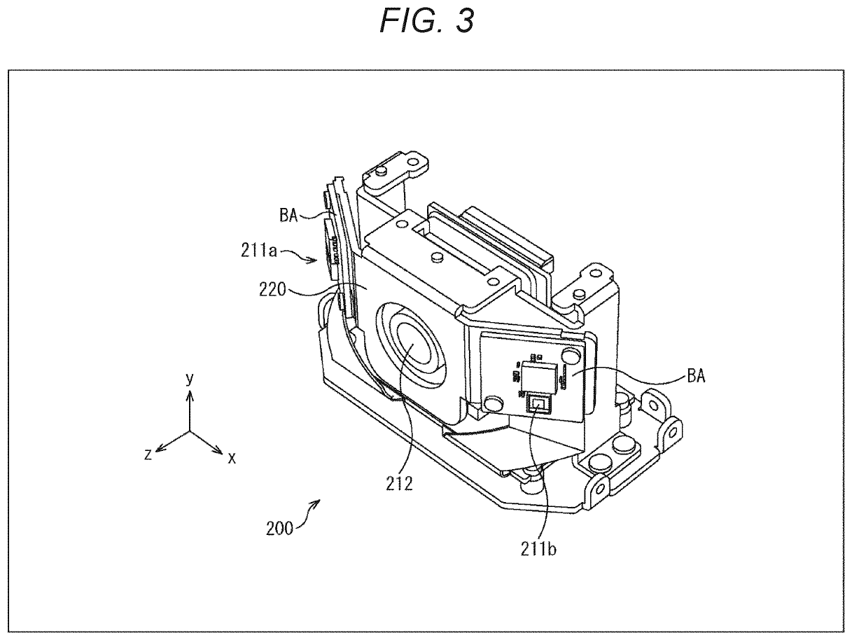

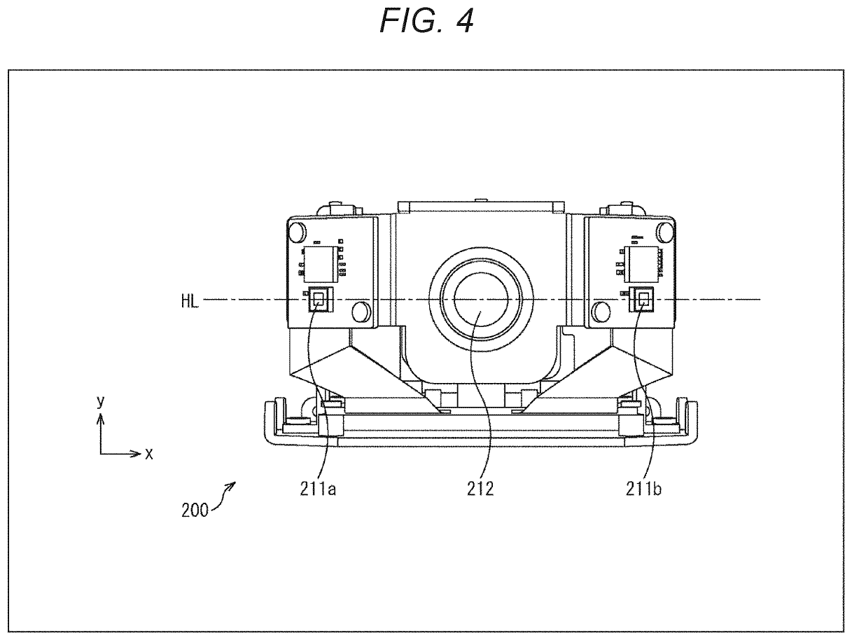

Here, a configuration example of a ToF camera according to the present embodiment that realizes the configuration of the distance measuring module 100 in FIG. 2 will be described with reference to FIGS. 3 and 4. FIG. 3 is a perspective view illustrating a configuration example of the ToF camera, and FIG. 4 is a front view illustrating the configuration example of the ToF camera.

The ToF camera 200 includes a pair of LDs 211a and 211b as the light emitting devices and a camera 212 as the imaging device.

Furthermore, the ToF camera 200 includes a housing frame 220 having a front surface and inclined surfaces, the front surface being a surface that faces a distance measuring object and where a lens of the camera 212 is exposed, the inclined surfaces being inclined at the same angle in a direction opposite to the imaging direction of the camera 212 (z-axis direction) on both sides of the front surface. In the ToF camera 200, each of the pair of LDs 211a and 211b is mounted on corresponding one of substrates BA provided on the inclined surfaces of the housing frame 220. Instead of the pair of LDs 211a and 211b, a pair of LEDs may be mounted on the respective substrates BA.

As illustrated in FIG. 4, in the ToF camera 200, the LDs 211a and 211b are disposed such that the centers of the respective light emitting surfaces and the center of the lens of the camera 212 are on a straight line HL (in the x-axis direction in the figure).

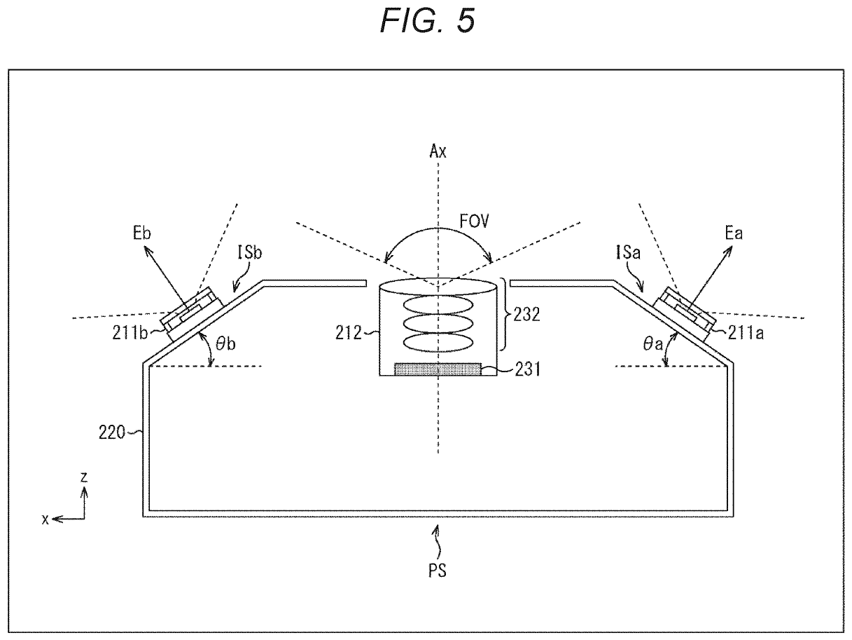

FIG. 5 is a diagram for explaining a positional relationship among the LDs 211a and 211b and the camera 212 in the ToF camera 200. FIG. 5 schematically illustrates the structure of the ToF camera 200 in top view.

As illustrated in FIG. 5, in the housing frame 220, an inclined surface ISa on which the LD 211a is provided is inclined by an angle θa with respect to the front surface where the lens of the camera 212 is exposed. Similarly, an inclined surface ISb on which the LD 211b is provided is inclined by an angle θb with respect to the front surface where the lens of the camera 212 is exposed. The angle θa and the angle θb have the same value, for example, a value between 35° and 39°. Thus, light emitting directions Ea and Eb of the respective LDs 211a and 211b are line-symmetric with respect to an optical axis Ax of the lens of the camera 212.

Furthermore, as illustrated in FIG. 5, the camera 212 includes an imaging element 231 and a lens group 232. The lens group 232 is configured as a wide-angle lens, and an angle of view FOV thereof is set to a value between 140° and 160°, for example.

With the above configuration, in which the pair of light emitting devices is disposed for one imaging device such that the respective light emitting directions have an inclination with respect to the optical axis of the imaging device, the irradiation range of the light emitting devices can be secured even for a wide imaging range such as 1600, for example. As a result, it is possible to achieve wide-angle distance measurement and downsizing of the apparatus, without disposition of a plurality of modules each including a pair of imaging device and light emitting device.

Furthermore, in the distance measuring module 100 (ToF camera 200), since only one imaging device needs to be provided, it is possible to achieve power saving and cost reduction as compared with a configuration in which a plurality of modules each including a pair of imaging device and light emitting device is disposed.

Furthermore, since the disposition of the light emitting devices which determines the irradiation range is defined by the support structure 120 (housing frame 220), it is possible to reduce the man-hours related to calibration and the like without requiring adjustment of the position and angle according to the imaging range of the imaging device.

Note that, as illustrated in FIG. 5, the housing frame 220 has a placement surface PS parallel to the imaging surface of the imaging element 231 included in the camera 212. That is, the ToF camera 200 can be installed on a surface facing the distance measuring object.

According to the structure illustrated in FIG. 5, the configurations of the LDs 211a and 211b are provided on the outer surface of the housing frame 220. Therefore, depending on components incorporated in the housing frame 220, the height of the entire ToF camera 200 can be reduced by bringing the placement surface PS close to the surface opposite to the imaging surface of the imaging element 231 (camera 212). Note that since the height of the entire ToF camera 200 is limited according to the design and specification of the lens group 232, the LDs 211a and 211b are required to be disposed lower in the height direction than the upper surface of the lens group 232 within a range in which the irradiation light of each of the LDs 211a and 211b is not blocked by the lens group 232.

### 3. Second Embodiment

In the distance measuring module of the present embodiment, a pair of light emitting devices is not disposed so as to sandwich an imaging device, but is disposed side by side so as to be adjacent to one side of the imaging device.

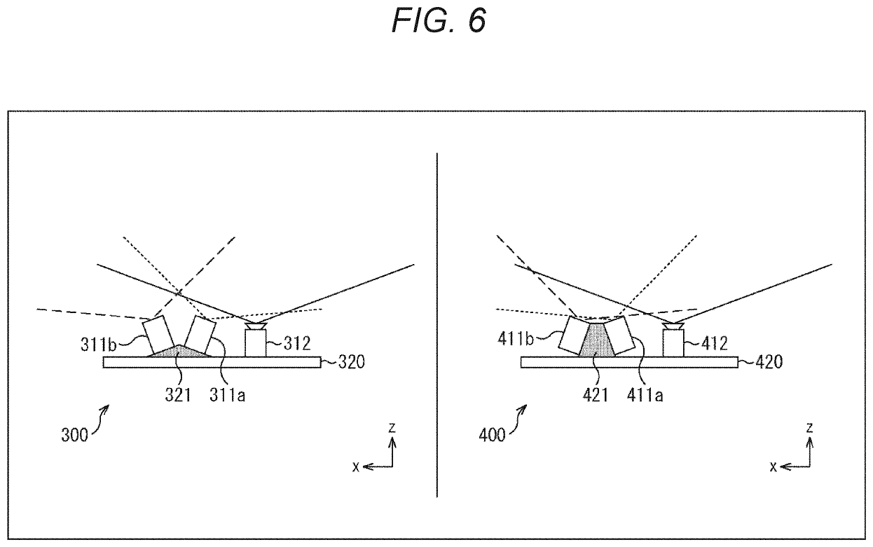

FIG. 6 is a diagram illustrating a configuration example of a distance measuring module of a second embodiment to which the technology according to the present disclosure is applied. FIG. 6 illustrates a distance measuring module 300 and a distance measuring module 400 of different aspects.

The distance measuring module 300 illustrated on the left of FIG. 6 includes a pair of light emitting devices 311a and 311b and an imaging device 312.

Also in the distance measuring module 300, although not illustrated, the light emitting devices 311a and 311b are disposed in such positions and at such angles that a combined irradiation range including an overlapping portion of respective irradiation ranges of the irradiation light includes an imaging range of the imaging device 312.

Specifically, the light emitting devices 311a and 311b are disposed side by side so as to be adjacent to the left side (x-axis direction side) of the imaging device 312 such that the respective light emitting directions thereof are inclined with respect to the optical axis of a lens of the imaging device 312. Of course, the light emitting devices 311a and 311b may be disposed side by side so as to be adjacent to the right side (the opposite side in the x-axis direction) of the imaging device 312.

Furthermore, the respective light emitting devices 311a and 311b emit irradiation light having the same light emission intensity at the same timing.

Furthermore, the distance measuring module 300 includes a support substrate 320 on which the light emitting devices 311a and 311b and the imaging device 312 are mounted as a support structure that supports the light emitting devices 311a and 311b and the imaging device 312.

In the distance measuring module 300, the light emitting devices 311a and 311b are mounted on the support substrate 320 via a mount member 321 having inclined surfaces inclined at the same angle in a direction opposite to the imaging direction of the imaging device 312 (z-axis direction) with respect to the imaging surface thereof. In particular, the light emitting devices 311a and 311b are mounted on the mount member 321 such that the central axes of the respective light emitting directions do not intersect each other. The mount member 321 may include an LED mount, an LD mount, or the like.

The distance measuring module 400 illustrated on the right of FIG. 6 includes a pair of light emitting devices 411a and 411b and an imaging device 312.

Also in the distance measuring module 400, although not illustrated, the light emitting devices 411a and 411b are disposed in such positions and at such angles that a combined irradiation range including an overlapping portion of respective irradiation ranges of the irradiation light includes an imaging range of the imaging device 412.

Specifically, the light emitting devices 411a and 411b are disposed side by side so as to be adjacent to the left side (x-axis direction side) of the imaging device 412 such that the respective light emitting directions thereof are inclined with respect to the optical axis of a lens of the imaging device 412. Of course, the light emitting devices 411a and 411b may be disposed side by side so as to be adjacent to the right side (the opposite side in the x-axis direction) of the imaging device 412.

Furthermore, the respective light emitting devices 411a and 411b emit irradiation light having the same light emission intensity at the same timing.

Furthermore, the distance measuring module 400 includes a support substrate 420 on which the light emitting devices 411a and 411b and the imaging device 412 are mounted as a support structure that supports the light emitting devices 411a and 411b and the imaging device 412.

In the distance measuring module 400, the light emitting devices 411a and 411b are mounted on the support substrate 420 via a mount member 421 having inclined surfaces inclined at the same angle in a direction opposite to the imaging direction of the imaging device 412 (z-axis direction) with respect to the imaging surface thereof. In particular, the light emitting devices 411a and 411b are mounted on the mount member 421 such that the central axes of the respective light emitting directions intersect each other. The mount member 421 may include an LED mount, an LD mount, or the like.

Also with the above configuration, in which the pair of light emitting devices is disposed for one imaging device such that the respective light emitting directions have an inclination with respect to the optical axis of the imaging device, the irradiation range of the light emitting devices can be secured even for a wide imaging range such as 160°, for example. As a result, it is possible to achieve wide-angle distance measurement and downsizing of the apparatus, without disposition of a plurality of modules each including a pair of imaging device and light emitting device.

Furthermore, in the distance measuring module 300 and the distance measuring module 400 of the present embodiment, the pair of light emitting devices can be disposed close to each other as compared with the distance measuring module 100 of the first embodiment (FIG. 2). In particular, in the distance measuring module 400, the pair of light emitting devices can be disposed closer to each other than those of the distance measuring module 300. This makes it possible to further reduce the size of the apparatus.

### 4. Third Embodiment

In the distance measuring module of the present embodiment, vertically-wide distance measurement is accomplished instead of the horizontally-wide distance measurement as in the above-described embodiments.

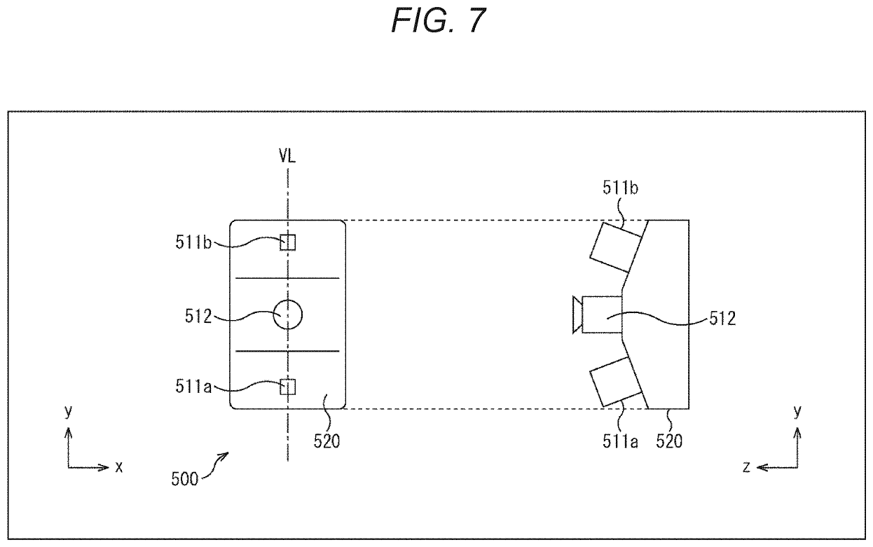

FIG. 7 is a diagram illustrating a configuration example of a distance measuring module of a third embodiment to which the technology according to the present disclosure is applied.

A distance measuring module 500 illustrated in FIG. 7 includes a pair of light emitting devices 511a and 511b and an imaging device 512.

Also in the distance measuring module 500, although not illustrated, the light emitting devices 511a and 511b are disposed in such positions and at such angles that a combined irradiation range including an overlapping portion of respective irradiation ranges of the irradiation light includes an imaging range of the imaging device 512.

Specifically, the light emitting devices 511a and 511b are disposed so as to sandwich the imaging device 512 such that the respective light emitting directions have an inclination with respect to the optical axis of a lens of the imaging device 512. More specifically, the light emitting devices 511a and 511b are disposed such that the respective light emitting directions are line-symmetric with respect to the optical axis direction of the lens (z-axis direction).

Furthermore, the light emitting devices 511a and 511b are disposed such that the centers of the respective light emitting surfaces and the center of the lens of the imaging device 512 are on a straight line VL (in the y-axis direction in the figure).

Furthermore, the distance measuring module 500 includes a support structure 520 that is configured as a housing frame or a support substrate and supports the light emitting devices 511a and 511b and the imaging device 512.

According to the above configuration, it is possible to secure the irradiation range of the light emitting devices even for the vertically-wide imaging range, and as a result, it is possible to achieve both wide-angle distance measurement and downsizing of the apparatus.

### 5. Application Example

According to the distance measuring module to which the technology according to the present disclosure is applied, it is possible to acquire a distance image of a distance measuring object in a short distance and in a wide range.

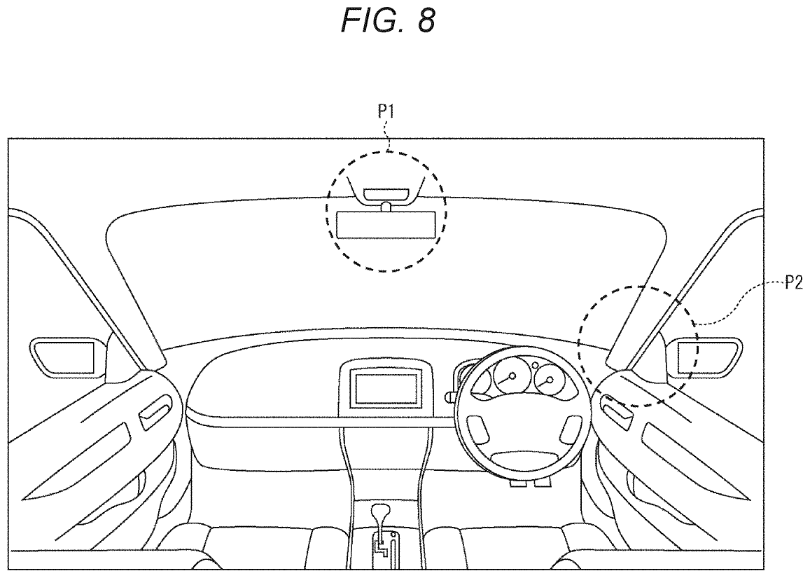

As illustrated in FIG. 8, the distance measuring module to which the technology according to the present disclosure is applied can be installed in an area P1 near a rearview mirror in an automobile. This makes it possible to grasp the driving state of the driver and the seating situation of the fellow passenger through detection of the action and the line of sight of the occupants, estimation of the skeleton of the occupants, and the like on the basis of the distance image acquired by the distance measuring module.

Furthermore, as illustrated in FIG. 8, the distance measuring module to which the technology according to the present disclosure is applied may be installed in an area P2 near a door mirror on a driver's seat side. This makes it possible to grasp at least the driving state of the driver on the basis of the distance image acquired by the distance measuring module.

Note that, in the distance measuring modules of the above-described embodiments, a pair of (two) light emitting devices is provided for one imaging device. However, it is sufficient that the light emitting devices are disposed in such positions and at such angles that the combined irradiation range thereof includes the imaging range of the imaging device, and three or more light emitting devices may be provided for one imaging device.

The effects described in the present specification are merely examples and are not limited, and other effects may be provided.

Furthermore, embodiments to which the technology according to the present disclosure is applied are not limited to the above-described embodiments, and various modifications can be made without departing from the scope of the technology according to the present disclosure.

Moreover, the present disclosure may have the following configurations.

(1)

A distance measuring module including:
a plurality of light emitting devices that emits irradiation light to a distance measuring object; and
an imaging device that captures an image of reflected light of the irradiation light reflected by the distance measuring object, in which
the plurality of light emitting devices is disposed in such positions and at such angles that a combined irradiation range including an overlapping portion of respective irradiation ranges of the irradiation light includes an imaging range of the imaging device.
   (2)

The distance measuring module according to (1), in which
the plurality of light emitting devices is disposed such that respective light emitting directions have an inclination with respect to an optical axis of a lens included in the imaging device.
   (3)

The distance measuring module according to (2), in which
the respective ones of the plurality of light emitting devices emit the irradiation light having the same light emission intensity at the same light emission timing.
   (4)

The distance measuring module according to (3), in which
a pair of the light emitting devices is disposed such that the respective light emitting directions are line-symmetric with respect to the optical axis of the lens.
   (5)

The distance measuring module according to (4), in which
the pair of light emitting devices is disposed such that centers of respective light emitting surfaces and a center of the lens are on substantially the same straight line.
   (6)

The distance measuring module according to (5), in which
the pair of light emitting devices is disposed such that parts of the respective irradiation ranges overlap at a distance of at most 50 cm from the lens.
   (7)

The distance measuring module according to any one of (1) to (6), in which
the pair of light emitting devices is disposed so as to sandwich the imaging device.
   (8)

The distance measuring module according to (7), further including:
a housing frame having a front surface and inclined surfaces, the front surface being a surface that faces the distance measuring object and where the lens is exposed, the inclined surfaces being inclined at the same angle in a direction opposite to an imaging direction of the imaging device on both sides of the front surface, in which
each of the pair of light emitting devices is provided on corresponding one of the inclined surfaces.
   (9)

The distance measuring module according to (8), in which
the housing frame has a placement surface parallel to an imaging surface of the imaging device.
   (10)

The distance measuring module according to any one of (1) to (6), in which
the pair of light emitting devices is disposed side by side so as to be adjacent to one side of the imaging device.
   (11)

The distance measuring module according to (10), further including:
a support substrate on which the imaging device and the pair of light emitting devices are mounted, in which
the pair of light emitting devices is mounted on the support substrate via a mount member having inclined surfaces inclined at the same angle in a direction opposite to an imaging direction of the imaging device.
   (12)

The distance measuring module according to (11), in which
the pair of light emitting devices is mounted on the mount member such that central axes of the respective light emitting directions do not intersect each other.
   (13)

The distance measuring module according to (11), in which
the pair of light emitting devices is mounted on the mount member such that central axes of the respective light emitting directions intersect each other.
   (14)

The distance measuring module according to any one of (1) to (6), in which
a lens included in the imaging device is a wide-angle lens having an angle of view of 1400 or more.
   (15)

The distance measuring module according to any one of (1) to (6), in which
each of the light emitting devices includes a light emitting diode (LED) or a laser diode (LD).

### REFERENCE SIGNS LIST

100 Distance measuring module
111a, 111b Light emitting device
112 Imaging device
120 Support member
200 ToF camera
211a, 211b LD
212 Camera
220 Housing frame
300 Distance measuring module
311a, 311b Light emitting device
312 Imaging device
320 Support substrate
321 Mount member
400 Distance measuring module
411a, 411b Light emitting device
412 Imaging device
420 Support substrate
421 Mount member

1. A distance measuring module comprising:
a plurality of light emitting devices that emits irradiation light to a distance measuring object; and
an imaging device that captures an image of reflected light of the irradiation light reflected by the distance measuring object, wherein
the plurality of light emitting devices is disposed in such positions and at such angles that a combined irradiation range including an overlapping portion of respective irradiation ranges of the irradiation light includes an imaging range of the imaging device.

2. The distance measuring module according to claim 1, wherein
the plurality of light emitting devices is disposed such that respective light emitting directions have an inclination with respect to an optical axis of a lens included in the imaging device.

3. The distance measuring module according to claim 2, wherein
the respective ones of the plurality of light emitting devices emit the irradiation light having the same light emission intensity at the same light emission timing.

4. The distance measuring module according to claim 3, wherein
a pair of the light emitting devices is disposed such that the respective light emitting directions are line-symmetric with respect to the optical axis of the lens.

5. The distance measuring module according to claim 4, wherein
the pair of light emitting devices is disposed such that centers of respective light emitting surfaces and a center of the lens are on substantially the same straight line.

6. The distance measuring module according to claim 5, wherein
the pair of light emitting devices is disposed such that parts of the respective irradiation ranges overlap at a distance of at most 50 cm from the lens.

7. The distance measuring module according to claim 6, wherein
the pair of light emitting devices is disposed so as to sandwich the imaging device.

8. The distance measuring module according to claim 7, further comprising:
a housing frame having a front surface and inclined surfaces, the front surface being a surface that faces the distance measuring object and where the lens is exposed, the inclined surfaces being inclined at the same angle in a direction opposite to an imaging direction of the imaging device on both sides of the front surface, wherein
each of the pair of light emitting devices is provided on corresponding one of the inclined surfaces.

9. The distance measuring module according to claim 8, wherein
the housing frame has a placement surface parallel to an imaging surface of the imaging device.

10. The distance measuring module according to claim 6, wherein
the pair of light emitting devices is disposed side by side so as to be adjacent to one side of the imaging device.

11. The distance measuring module according to claim 10, further comprising:
a support substrate on which the imaging device and the pair of light emitting devices are mounted, wherein
the pair of light emitting devices is mounted on the support substrate via a mount member having inclined surfaces inclined at the same angle in a direction opposite to an imaging direction of the imaging device.

12. The distance measuring module according to claim 11, wherein
the pair of light emitting devices is mounted on the mount member such that central axes of the respective light emitting directions do not intersect each other.

13. The distance measuring module according to claim 11, wherein
the pair of light emitting devices is mounted on the mount member such that central axes of the respective light emitting directions intersect each other.

14. The distance measuring module according to claim 1, wherein
a lens included in the imaging device is a wide-angle lens having an angle of view of 140° or more.

15. The distance measuring module according to claim 1, wherein
each of the light emitting devices includes a light emitting diode (LED) or a laser diode (LD).
